(19) United States
(12) Patent Application Publication
(10) Pub. No.: US 2026/0288947 A1
(43) Pub. Date: Sep. 24, 2026

(54) MANAGING OPERATION OF A STORAGE DEVICE BASED ON AN INTRUSION EVENT

(71) Applicant: Dell Products L.P., Round Rock, TX (US)

(72) Inventors: PHANINDRA BHARGAV TALASILA, Georgetown, TX (US); ADOLFO SANDOR MONTERO, Pflugerville, TX (US); IBRAHIM SAYYED, Georgetown, TX (US); XIAOMEI ZHU MILLER, Round Rock, TX (US)

(21) Appl. No.: 19/085,719

(22) Filed: Mar. 20, 2025

(51) Int. Cl. G06F 21/55

(52) U.S. Cl. CPC G06F 21/554; G06F 2221/034

(57) ABSTRACT

Methods and systems for managing operation of a data processing system are disclosed. To manage the data processing system, a management controller of the data processing system may identify an intrusion event related to an attempt by an entity to gain unauthorized access to the data processing system. Once identified, the management controller may identify a remediation action with respect to a storage device of the data processing system. The remediation action may be performed, cooperatively between the management controller and the storage device using a side band channel, to place the storage device in a protected state (e.g., for reduced likelihood of unauthorized access by the entity).

### FIELD

Embodiments disclosed herein relate generally to managing operation of a data processing system. More particularly, embodiments disclosed herein relate to managing operation of the data processing system by using a management controller to manage operation of a storage device of the data processing system based on an intrusion event.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1C show diagrams illustrating a system in accordance with an embodiment.

FIGS. 2A-2B show interaction diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing systems may provide computer-implemented services to any type and number of other devices and/or users of the data processing systems. The computer-implemented services may include any quantity and type of such services.

To provide the computer-implemented services, a data processing system may host any number and/or types of storage devices. A storage device of the storage devices may include, for example, a solid-state drive that utilizes non-volatile memory express (NVMe) to provide its functionality. The storage device may store any number and/or type of information that may include, for example, sensitive information, data usable to boot the data processing system, an image of a management entity, and/or any other information usable to provide at least a portion of the computer-implemented services.

However, a quality of the computer-implemented services may be negatively impacted if an entity (e.g., a malicious entity) gains unauthorized access to hardware resources of the data processing system. For example, the malicious entity may perform a credential-based attack (e.g., brute force attack, dictionary attack, etc.), a chassis intrusion, a network-based attack, and/or utilize any other attack vectors to gain access to the data processing system without permission. If the malicious entity gains access to the hardware resources, the information stored on the storage device may be vulnerable to undesired access and/or manipulation.

An intrusion event may be identified based on an attempt by the entity to gain unauthorized physical and/or logical access to hardware resources of the data processing system. The hardware resources may utilize any number and/or types of components (e.g., sensors, processor, software, etc.) to identify the occurrence of the intrusion event. However, because the hardware resources may be compromised, an ability of the hardware resources to identify and/or address the intrusion event may be reduced.

To modify operation of the data processing system in an event of compromise and/or reduced functionality of at least a portion of the hardware resources, the data processing system may host a management controller that may operate independently from the hardware resources and may be distinct from and adapted to manage the hardware resources. For example, the management controller may operate during the booting process (e.g., regardless of an outcome of the booting process) and/or while the hardware resources may be in a potentially compromised state.

Thus, to reduce a likelihood that the information stored on the storage device may be accessed by an unauthorized entity, the storage device may be placed in a protected state when an intrusion event is identified to have occurred. To identify the occurrence of the intrusion event, the management controller may obtain information from a processor of the data processing system using a side band communication channel and while the processor may be in a predetermined state. For example, the processor may be in a booting state, a managed operating state, and/or any other state. Using at least the information, the management controller may infer that the intrusion event has occurred.

The management controller may subsequently identify a remediation action with respect to the storage device based on the intrusion event. For example, the remediation action may include updating operation of the storage device (e.g., powering down the storage device, restricting interaction with the processor, etc.), encrypting at least a portion of data stored on the storage device, deleting at least a portion of the data, and/or performing any other actions to place the storage device in a protected state.

Thus, embodiments disclosed herein may provide an improved method for managing operation of a data processing system by using a management controller to manage operation of a storage device based on an identification of an intrusion event. By doing so, the intrusion event may be addressed to facilitate continued provisioning of computer-implemented services by the data processing system.

In an embodiment, a method for managing operation of a data processing system is provided. The method may include: (i) identifying, by a management controller of the data processing system, an occurrence of an intrusion event related to an entity attempting to gain unauthorized access to hardware resources of the data processing system; (ii) based on the identifying: (a) identifying, by the management controller, a remediation action with respect to a storage device of the hardware resources, the remediation action being: (i) based on the intrusion event, and (ii) adapted to place the storage device in a protected state; and (b) managing, by the management controller via a side band channel, operation of the storage device using the remediation action to facilitate continued provisioning of computer-implemented services after the intrusion event is addressed through, at least in part, performance of the remediation action.

Identifying the occurrence of the intrusion event may include: (i) obtaining, by the management controller via a second side band channel, information from a processor while the processor is operating in a predetermined state, the information comprising attempted access activity by the entity; and (ii) inferring, by the management controller and based on the information, that the intrusion event has occurred.

The predetermined state may be a booting state while the processor is attempting to boot the data processing system.

The predetermined state may be a managed operating state while an operating system is managing operation of the processor.

Inferring that the intrusion event has occurred may include: (i) comparing at least a portion of the attempted access activity to intrusion detection criteria; and (ii) in an instance of the comparing where the at least the portion of the attempted access activity meets the intrusion detection criteria: (a) inferring that the intrusion event has occurred.

Identifying the remediation action may include: (i) searching, by the management controller, a repository of remediation actions using the intrusion event as a key to identify the remediation action.

The remediation action may be performed, cooperatively between the management controller and the storage device using the side band channel, regardless of an operating state of the hardware resources.

Managing operation of the storage device may include: (i) providing, by the management controller via the side band channel, a command to a controller of the storage device to perform the remediation action.

The remediation action may include updating operation of the storage device so that a processor of the hardware resources is unable to interact with the storage device.

The remediation action may include deleting at least a portion of data stored on the storage device so that the at least a portion of data is unavailable to a processor of the hardware resources.

The intrusion event may include at least one event selected from a list of events consisting of: (i) a credential-based attack; (ii) a chassis intrusion event; (iii) a firmware tampering event; and (iv a boot deviation attempt event.

The unauthorized access may include physical and/or logical access to the hardware resources without permission.

The management controller may operate independently from and be distinct from the hardware resources.

The management controller may be on a separate power domain from the hardware resources so that the management controller is operable while the hardware resources are inoperable.

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

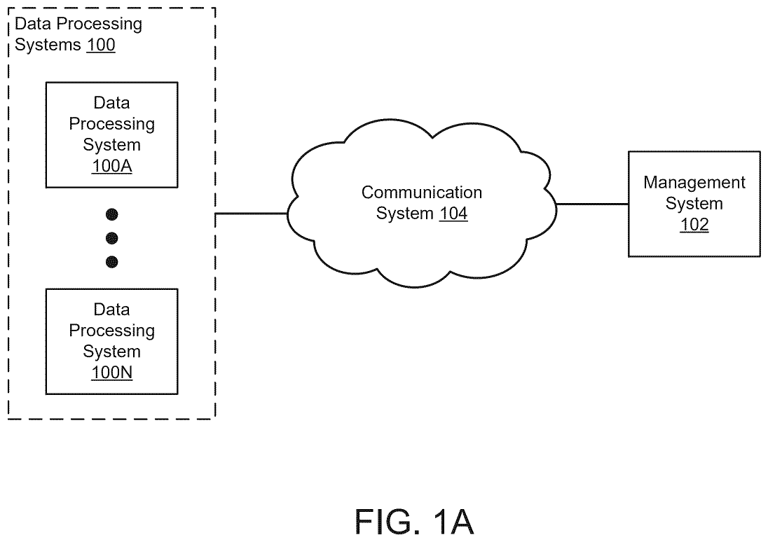

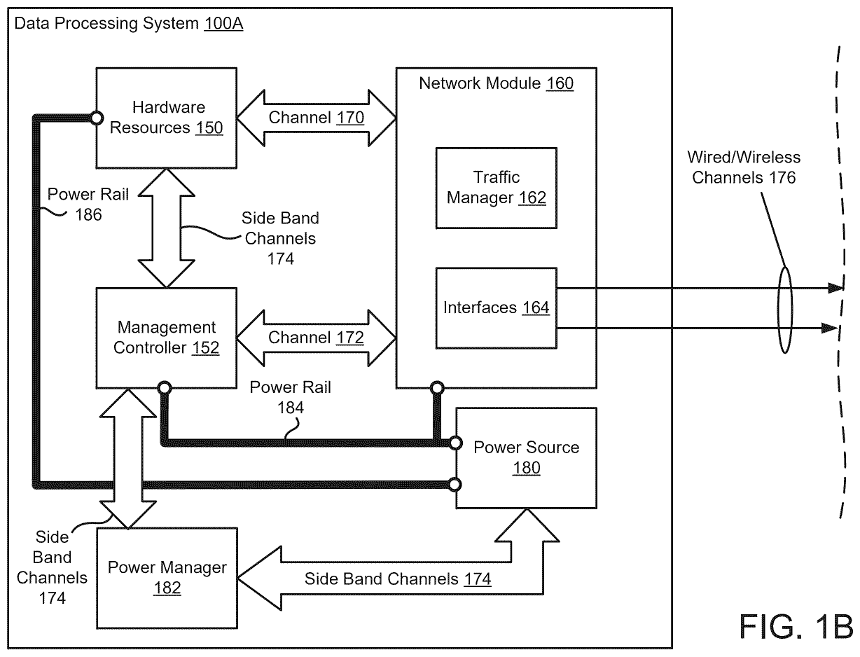

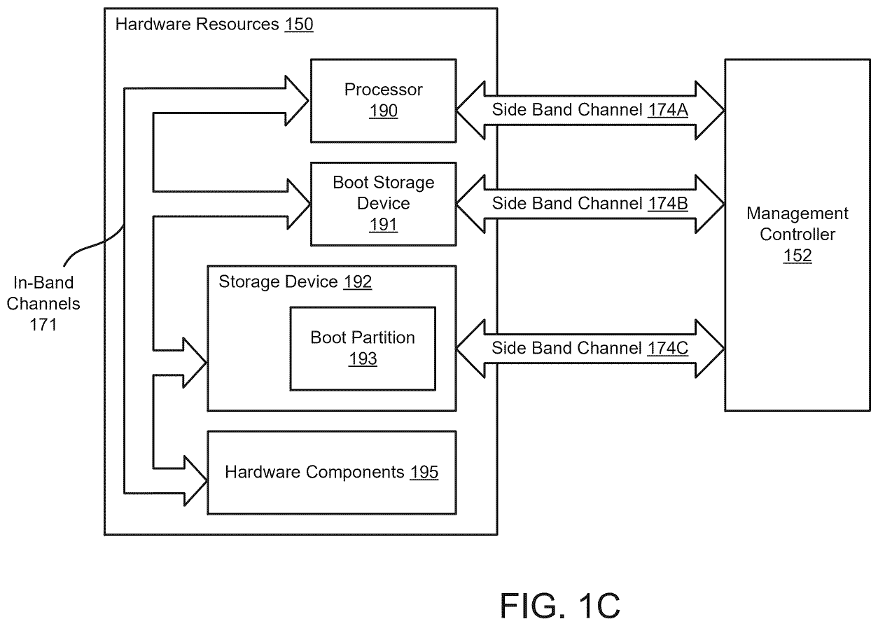

Turning to FIG. 1A, a block diagram illustrating a system in accordance with an embodiment is shown. The system shown in FIG. 1A may provide for management of data processing systems that may provide, at least in part, computer-implemented services (e.g., to user of the system and/or devices operably connected to the system).

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time. Refer to FIG. 1B for additional details regarding data processing systems 100.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1A). Other types of computer-implemented services may be provided by the system shown in FIG. 1A without departing from embodiments disclosed herein.

The computer-implemented services may be provided at least in part, by hardware resources of data processing systems 100. The hardware resources may include any number and/or types of storage devices. A storage device of the storage devices may include, for example, a solid-state drive that utilizes non-volatile memory (e.g., NAND flash memory) and a data transfer protocol (e.g., non-volatile memory express (NVMe)) to provide its functionality. To provide its functionality, the storage device may further include, for example, storage resources (e.g., flash memory cells), a controller (e.g., to manage operations of the storage device), an interface (e.g., to facilitate communication between the storage device and the processor), and/or any other components.

The storage device may host any number and/or types of data that may be used to provide at least a portion of the computer-implemented services. For example, the storage device may host an image of an operating system, application data (e.g., software programs), files (e.g., documents, images, etc.), startup data (e.g., that may be stored in a boot partition of the storage device), sensitive data, and/or any other information usable to provide at least a portion of the computer-implemented services.

However, a quality of the computer-implemented services may be negatively impacted if an entity (e.g., a malicious entity) gains unauthorized access to hardware resources of the data processing system. For example, the malicious entity may perform a credential-based attack (e.g., brute force attack, dictionary attack, etc.), a chassis intrusion, a network-based attack, and/or utilize any other attack vectors to gain access to the data processing system without permission. If the malicious entity gains access to the hardware resources, the information stored on the storage device may be vulnerable to undesired access and/or manipulation.

An intrusion event may be identified based on an attempt by the entity to gain unauthorized physical and/or logical access to hardware resources of the data processing system. The hardware resources may utilize any number and/or types of components (e.g., sensors, processor, software, etc.) to identify the occurrence of the intrusion event. However, because the hardware resources may be compromised, an ability of the hardware resources to identify and/or address the intrusion event may be negatively impacted.

To manage operation of the data processing system in an event of compromise and/or reduced functionality of at least a portion of the hardware resources, the data processing system may host a management controller that may operate independently from the hardware resources and may be distinct from and adapted to manage the hardware resources. For example, the management controller may operate during the booting process (e.g., regardless of an outcome of the booting process) and/or while the hardware resources may be in a potentially compromised state.

In general, embodiments disclosed herein relate to systems, devices, and methods for managing operation of a data processing system. To manage the operation of a data processing system, the management controller may obtain and/or provide information to hardware resources using a side band channel. For example, the management controller may identify the occurrence of an intrusion event related to an entity attempting to gain unauthorized access to the hardware resources based on information obtained from a processor of the hardware resources.

For example, consider a scenario in which a malicious entity attempts to gain unauthorized access to the data processing system by performing a brute force attack (e.g., inputting passwords using a trial-and-error approach) while the processor is attempting to boot (e.g., utilizing BIOS, UEFI, etc.). The management controller may obtain information (e.g., attempted access activity, incorrect password attempts, etc.) from the processor using the side band channel. The management controller may subsequently compare the information to intrusion detection criteria (e.g., a threshold for incorrect password attempts) to infer that the data processing system is being subjected to a brute force attack.

The management controller may subsequently identify a remediation action with respect to the storage device based on the intrusion event. To do so, the management controller may search a repository hosted by storage resources of the management controller, reference a policy provided by a management entity, and/or via any other processes.

For example, the remediation action may include updating operation of the storage device (e.g., powering down the storage device, restricting interaction with the processor, etc.), encrypting at least a portion of data stored on the storage device, deleting at least a portion of the data, and/or performing any other actions to place the storage device in a protected state.

Thus, to reduce a likelihood that the information stored on the storage device may be accessed by an unauthorized entity, the storage device may be placed in the protected state when an intrusion event is identified to have occurred. By doing so, operation of the storage device may be managed to facilitate continued provisioning of computer-implemented services by the data processing system after the intrusion event is addressed.

To provide the above noted functionality, the system may include data processing systems 100, and management system 102. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., management controller, network modules, etc.), and functionality that may allow the out-of-band components to communicate with management system 102 via an out-of-band communication channel.

While providing the at least a portion of the computer-implemented services, a data processing system (e.g., 100A) of data processing systems 100 may communicate with and/or obtain information from management system 102. For example, data processing system 100A may obtain instructions relevant to updated storage device software (e.g., an updated firmware version), implementing a storage device security policy, management requests to modify operation of the hardware resources (e.g., installing new applications), and/or any other information. Data processing system 100A may subsequently perform actions based on the information obtained from management system 102 to update operation of data processing system 100A.

Management system 102 may, as discussed above, provide remote management services. Management system 102 may include, for example, a second data processing system operated an owner of data processing systems 100. To provide the remote management services, management system 102 may interact with data processing systems 100 to obtain and/or provide information (e.g., data) relevant to operation of data processing systems 100. For example, management system 102 may implement and/or provide a storage device security policy to a data processing system of data processing systems 100 that may defines actions to be performed by a management controller of the data processing system in an event that an attempt to gain unauthorized access to the data processing system is detected.

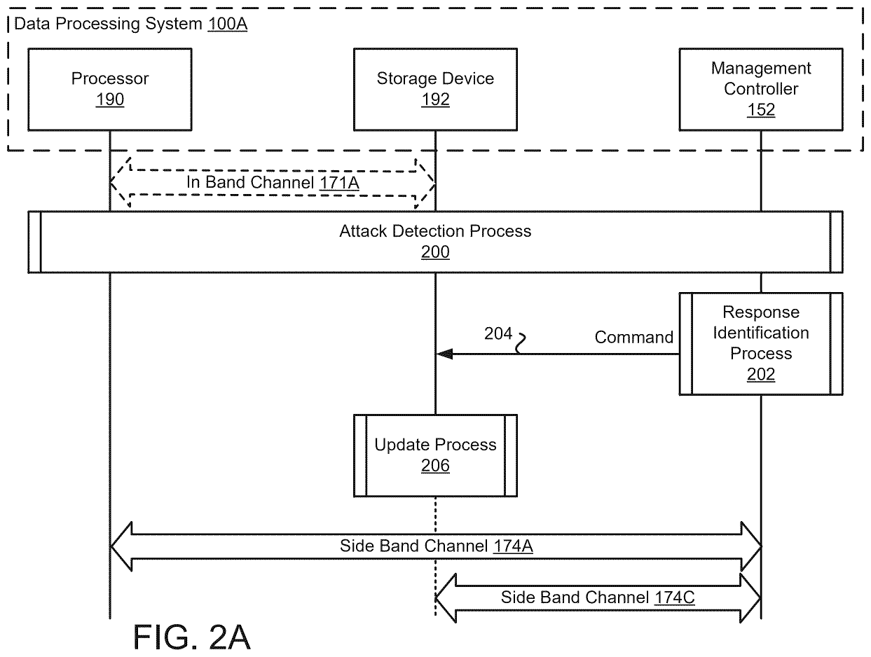

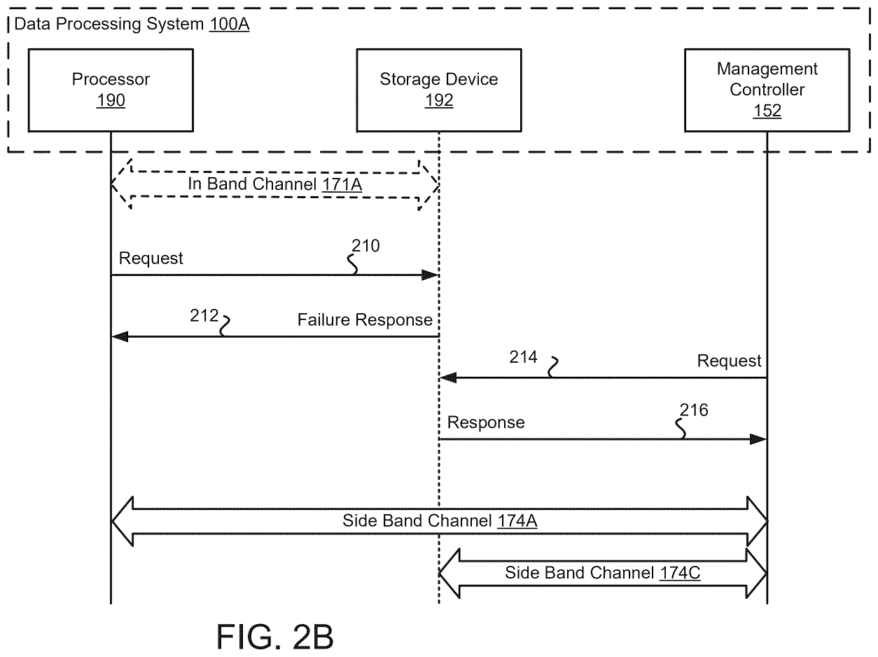

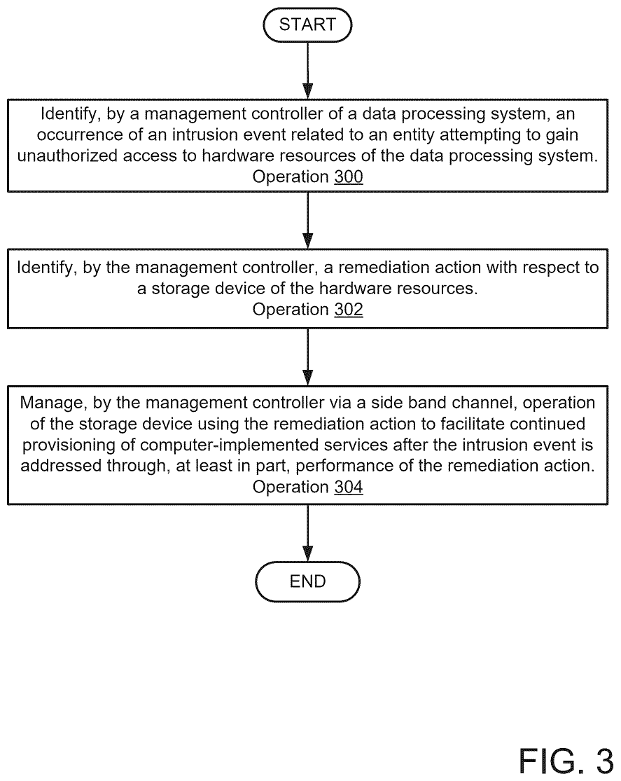

While providing their functionality, any of data processing systems 100, and management system 102 may provide all or a portion of the methods shown in FIGS. 2A-3.

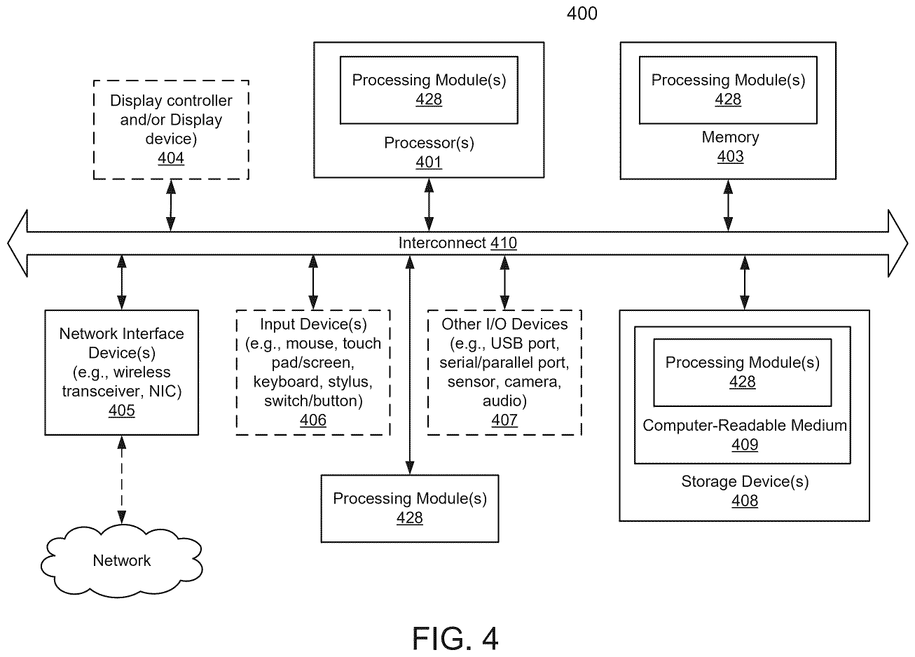

Communication system 104 may allow any of data processing systems 100, and management system 102 to communicate with one another (and/or with other devices not illustrated in FIG. 1A). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may manage operation of a data processing system by using a management controller to update operation of a storage device of the data processing system based on an intrusion event. By doing so, a likelihood that information stored on the storage device may be subject to undesired use may be reduced.

While illustrated in FIG. 1A with a limited number of specific components, a system may include additional, fewer, and/or different components without departing from embodiments disclosed herein.

Turning to FIG. 1B, a diagram illustrating a data processing system in accordance with an embodiment is shown. Data processing system 100A shown in FIG. 1B may be similar to any of the data processing systems shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The storage may include any number and/or types of storage devices (e.g., hard drives, solid state drives, etc.). A storage device of the storage devices may include, for example, memory (e.g., non-volatile memory), a controller that may manage data operations (e.g., storage, retrieval, organization, etc.), and/or other physical components. The storage device may support storage protocols (e.g., non-volatile memory express) that may facilitate use of storage resources of the storage device.

For example, the storage may include a first storage device adapted to host an image of a startup management entity (e.g., basic input/output system (BIOS), unified extensible firmware interface (UEFI), etc.), system configurations, and/or any other information. Additionally, the storage may include a second storage device that may include, but not be limited to, storage for information necessary to boot the data processing system, load an operating system for the data processing system, and/or perform any other processes.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing hardware resources 150 to communicate with other devices via packet switched networks and/or other types of communication networks.

The processor may also host various applications that provide the computer-implemented services. The applications may utilize various services provided by the management entities and use (at least indirectly) the network stack to communication with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 140 may include management controller 152 and network module 160. Each of these components of data processing system 140 is discussed below.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band components, may manage power distribution, thermal management, and/or other functions of data processing system 100A.

To provide the management functionalities, management controller 152 may utilize data that may, at least temporarily be stored on storage resources hosted by management controller 152. For example, management controller may download an image of a new management entity (e.g., firmware, application, etc.) in response to a management request, store the image, and install the new management entity using at least the image on hardware resources 150.

To do so, management controller 152 may be operably connected to various components via side band channels 174 (in FIG. 1B, a limited number of side band channels are included for illustrative purposes, it will be appreciated that management controller 152 may communication with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, storage devices of hardware resources 150 may not be operably connected to a processor (e.g., due to in-band channels between the processor and the storage devices not being functional during the booting process). Management controller 152 may communicate with the processor, the boot storage device, and the storage device via side band channels 174. By doing so, management controller 152 may obtain and perform management functionalities (e.g., identifying an occurrence of an intrusion event related to an entity attempting to gain unauthorized access to the data processing system, identify a remediation access based on the intrusion event, provide a command to a storage device to perform the remediation process, etc.) regardless of an operating state of hardware resources 150.

To facilitate communication with other devices, data processing system 100A may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2A-3.

While illustrated in FIG. 1B with a limited number of specific components, a system may include additional, fewer, and/or different components without departing from embodiments disclosed herein.

Turning to FIG. 1C, to provide computer-implemented services, hardware resources 150 may host processor 190, boot storage device 191, and storage device 192. For example, to place a data processing system (e.g., 100A) in a desired operating state, data processing system 100A may perform a booting process to initialize hardware resources and facilitate operation of an operating system. To do so, processor 190 may execute instructions indicated by boot data (e.g., firmware, system configuration, etc.) hosted by boot storage device 191.

Boot storage device 191 may include, for example, non-volatile flash memory (e.g., serial peripheral interface (SPI) flash) that may be hosted on a motherboard and adapted to store information, such as firmware, an image of a management entity (BIOS, unified extensible firmware interface (UEFI), etc.), system configuration files, and/or any other information usable to boot data processing system 100A. Because boot storage device 191 may have a limited storage capacity, storage device 192 may be used to store additional information (e.g., other copies of boot data).

Storage device 192 may include, for example, a second storage device such as a non-volatile memory express (NVMe) based solid-state drive. Storage device 192 may include a boot partition (193) that may be configured to store data usable to boot data processing system 100A (e.g., a desired of boot data, bootloader files, configuration files, etc.). Boot partition 193 may include an allocated section of storage device 192 that may, for example, be isolated from other memory sections of storage device 192. Furthermore, to provide its functionality, storage device 192 may include storage resources (e.g., flash memory cells), a controller (e.g., to manage operations of the storage device), an interface (e.g., to facilitate communication between the storage device and the processor), and/or any other components.

Processor 190 may include a central processing unit (CPU) that may interact with any number and/or type of other hardware components (e.g., boot storage device 191, storage device 192, and hardware components 195). For example, when data processing system 100A is powered on, processor 190 may be initialized to a predetermined state and directed to retrieve instructions (e.g., via a reset vector) from boot storage device 191. To interact with boot storage device 191, storage device 192, and/or the other hardware components, processor 190 may be operably connected to each of the components via in-band channels 171.

However, at least a portion of in-band channels 171 may not be functional and/or may have reduced functionality during booting of data processing system 100A and/or while hardware resources 150 may be in a potentially compromised state. For example, in an event that storage device 192 and/or hardware components 195 are not initialized during booting, processor 190 may not be able to communicate with storage device 192 to obtain data required to place data processing system 100A in a desired operating state.

Thus, to improve a likelihood that data processing system 100A may be placed in the desired operating state, management controller 152 may perform management functionalities using any number and/or type of side band channels (e.g. 174). For example, management controller may obtain information (e.g., attempted access activity, sensor data, etc.) from processor 190 using side band channel 174A, monitor a status of boot storage device 191 with respect to unauthorized access using side band channel 174B, issue commands to storage device 192 to perform a remediation action using side band channel 174C, and/or perform any other actions by communicating with components of hardware resources regardless of an operating status of hardware resources 150.

To further clarify embodiments disclosed herein, interaction diagrams in accordance with an embodiment are shown in FIGS. 2A-2B. The interaction diagrams may illustrate how data may be obtained and used within the system of FIGS. 1A-1C.

In the interaction diagrams, processes performed by and interactions between components of a system in accordance with an embodiment are shown. In the diagrams, components of the system are illustrated using a first set of shapes (e.g., 190, 192, etc.), located towards the top of each figure. Lines descend from these shapes. Processes performed by the components of the system are illustrated using a second set of shapes (e.g., 200, 202, etc.) superimposed over these lines. Interactions (e.g., communication, data transmissions, etc.) between the components of the system are illustrated using a third set of shapes (e.g., 204, 210, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the process labeled as 200 may occur prior to the process labeled as 202. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during updating operation of a storage device of a data processing system based on an intrusion event identified for the data processing system.

To update operation of the storage device based on the intrusion event, attack detection process 200 may be performed. During attack detection process 200, information may be obtained from processor 190 regarding attempted access activity, and an occurrence of an intrusion event may be inferred based on the information. Processor 190 may generate the information while operating in a predetermined state. For example, consider a scenario in which processor 190 is in a booting state while processor 190 is attempting to boot data processing system 100A using data (e.g., firmware) hosted on a boot storage device (not shown). A malicious entity may attempt to gain control and/or otherwise modify operation of processor 190 by performing an attack aimed to gain physical and/or logical access to hardware resources without permission.

Management controller 152 may obtain the information regarding the attempted access activity from processor 190 by accessing the information (e.g., incorrect password attempts, sensor information, results of data processing, list of applications, etc.) using side band channel 174A, receiving a notification from processor 190 that indicates that undesired activity may be occurring (e.g., based on BIOS configurations), receiving the information from a software agent hosted by hardware resources 150 while managed by an operating system, and/or via any other processes.

Based on the information, management controller 152 may infer that an intrusion event has occurred. To do so, management controller 152 may compare at least a portion of the information to intrusion detection criteria. For example, the intrusion detection criteria may include a threshold for incorrect password attempts (e.g., 5 incorrect password attempts). If the entity exceeds the threshold (e.g., while performing a brute force attack), management controller 152 may infer that an intrusion event has occurred. Additionally, management controller 152 may obtain a policy (e.g., obtained from management system 102, configured for data processing system 100A, etc.) that may define any number and/or types of factors to consider as a basis for identifying the intrusion event.

To address the intrusion event, response identification process 202 may be performed. During response identification process 202, management controller 152 may identify at least one remediation action with respect to storage device 192. To do so, management controller 152 may search a repository of remediation actions using information regarding the intrusion event as a key (e.g., a type of attack, identifier of data processing system 100A, etc.), obtain a response from a remote management entity (e.g., using an out-of-band communication channel, not shown), and/or perform any other actions to identify the remediation action adapted to place storage device 192 in a protected state (e.g., to prevent unauthorized access of data stored on storage device 192 by a malicious entity).

At interaction 204, a command may be provided to storage device 192 by management controller 152. The command may include, for example, instructions to perform the remediation action identified during response identification process 202. To provide the command, management controller 152 may issue the command via a message to a controller of storage device 192 using side band channel 174C (e.g., utilizing a data transfer protocol, such as NVMe).

To place storage device 192 in the protected state, update process 206 may be performed. During update process 206, storage device 192 may perform at least a portion of the remediation action based on the command from management controller 152. For example, to perform the portion of the remediation action, (i) storage device 192 may be depowered, (ii) at least a portion of storage resources (e.g., selected partitions) hosted by storage device 192 may be deleted, (iii) a communication channel between storage device 192 and processor 190 may be restricted, (iv) a portion of the storage resources may be encrypted, and/or any other actions may be performed to limit interaction and/or data available to processor 190. The line descending from storage device 192 is shown in short-dashed lines following update process 206 to indicate a change in operating state (e.g., depowered, reduced functionality, etc.) of storage device 192.

Side band channels (e.g., 174A, 174C) may be used to facilitate communication between management controller 152 and storage device 192, and are shown to indicate that management controller 152 may interface with processor 190, and storage device 192 regardless of a status of in-band channels (e.g., that may have reduced functionality due to the undesired boot event). Using the side band channels, management controller 152 may perform management commands that may include, for example, accessing data regarding operation of processor 190, performing a remediation action to place storage device 192 in a protected state, and/or performing any other actions.

Thus, using processes and interactions shown in FIG. 2A, operation of a storage device may be updated to address an intrusion event related to an entity attempted to gain unauthorized access to a data processing system. By doing so, information stored on the storage device may be less likely to be susceptible to the unauthorized access.

Turning to FIG. 2B, a second interaction diagram in accordance with an embodiment is shown. The second interaction diagram may illustrate processes and interactions that may occur during request processing by the storage device while in a protected state (e.g., following processes and interactions performed in FIG. 2A).

At interaction 210, a request may be attempted to be provided by processor 190 to storage device 192. The request may include a request to read and/or write data hosted by storage device 192, manage operation of storage device 192 (e.g., power on, establish communication, modify previously established restrictions, etc.). The request may be attempted to be provided, for example, via a message transmitted by processor 190 to a controller of storage device 192 using in band channel 171A.

At interaction 212, a failed response may be provided to processor 190. The failed response may be provided to processor 190 via (i) a null response to the request provided at interaction 210 (e.g., based on a request timeout, unsuccessful transmission of the message, etc.), (ii) a denial response to the request (e.g., based on restrictions enforced on storage device 192, lack of permission for processor 190, etc.), and/or any other response and/or lack of response that may indicate that the request from processor 190 was not performed.

At interaction 214, a second request may be provided to storage device 192 by management controller 152. The request may similarly include, for example, a request to read and/or write data hosted by storage device 192, manage operation of storage device 192 (e.g., power on, establish communication, modify previously established restrictions, etc.). The request may be attempted to be provided via a message transmitted by management controller 152 to a controller of storage device 192 using side band channel 174C.

At interaction 216, a response may be provided to management controller 152 by storage device 192. For example, the response may be provided by: (i) locating the requested data (e.g., on storage resources of a controller of storage device 192, flash memory cells of storage device 192, etc.), (ii) transferring the requested data to management controller via side band channel 174C and/or using a data transfer protocol (e.g., NVMe, etc.), (iii) providing confirmation of an action performed based on the request, and/or via any other processes.

Thus, using processes and interactions shown in FIG. 2B, interactions between the storage device and the processor may be limited while operation of the storage device is managed by the management controller. By doing so, the storage device may be secured while the intrusion event is addressed so that computer-implemented services may be continued to be provided by the data processing system after the intrusion event is addressed.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1C may perform various methods to manage a data processing system. FIG. 3 illustrate methods that may be performed by the components of the system of FIGS. 1A-1C. In the diagrams discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a data processing system in accordance with an embodiment is shown. The method may be performed, for example, by any of the components of the system of FIGS. 1A-1C, and/or other components not shown therein.

At operation 300, an occurrence of an intrusion event related to an entity attempting to gain unauthorized access to hardware resources of the data processing system may be identified. The occurrence of the intrusion event may be identified by a management controller of the data processing system. To do so, the management controller may (i) monitor results of data processing performed by a processor of the hardware resources while the processor attempts to boot the data processing system (e.g., utilizing BIOS), (ii) compare attempted access activity to intrusion detection criteria (e.g., maximum incorrect password attempts, attempted access to a secured storage of a boot storage device, attempted communication with remote entities, etc.), (iii) receive a notification from the processor based on a policy that indicates that the data processing system may be under attack, and/or via any other processes. The intrusion event may include, for example, a credential-based attack (e.g., brute force attack, dictionary attack, etc.), a chassis intrusion event, a firmware tampering event, a boot deviation attempt (e.g., network boot attempt, external device boot attempt, etc.), and/or any other attempt to gain physical and/or logical access to the hardware resources without permission.

At operation 304, a remediation action may be identified with respect to a storage device of the hardware resources. The remediation action may be identified by the management controller by (i) searching a repository of remediation actions hosted by the management controller and using information regarding the intrusion event as a key (e.g., a type of attack, a target of the attack, an identifier of the data processing system, etc.), (ii) obtaining a security policy for the storage device (e.g., a level of confidentiality for portions of data stored on the storage device), (iii) obtaining the remediation action from a remote management entity, and/or performing any other actions.

At operation 306, operation of the storage device may be managed using the remediation action. The operation of the storage device may be managed by the management controller by (i) issuing a command to a controller of the storage device to perform at least a portion of the remediation action, (ii) depowering the storage device, (iii) restricting communication of the storage device so that a processor is unable to interact with the storage device (e.g., while the processor may be in a potentially compromised state), (iv) encrypting at least a portion of the data stored on the storage device, (v) deleting at least a portion of the data so that the portion of the data is not available to the processor, and/or performing any other actions.

The method may end following operation 306.

Using the method shown in FIG. 3, operation of a data processing system may be managed using a management controller to identify that an intrusion event may have occurred related to an unauthorized entity attempting to access the data processing system. Once identified, the management controller may identify a remediation action with respect to a storage device and update operation of the storage device. By doing so, hosted by the storage device may be less likely to be accessed by the unauthorized entity.

Any of the components illustrated in FIGS. 1A-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing operation of a data processing system, the method comprising:
identifying, by a management controller of the data processing system, an occurrence of an intrusion event related to an entity attempting to gain unauthorized access to hardware resources of the data processing system;
based on the identifying:
identifying, by the management controller, a remediation action with respect to a storage device of the hardware resources, the remediation action being:
based on the intrusion event, and
adapted to place the storage device in a protected state; and
managing, by the management controller via a side band channel, operation of the storage device using the remediation action to facilitate continued provisioning of computer-implemented services after the intrusion event is addressed through, at least in part, performance of the remediation action.

2. The method of claim 1, wherein identifying the occurrence of the intrusion event comprises:
obtaining, by the management controller via a second side band channel, information from a processor while the processor is operating in a predetermined state, the information comprising attempted access activity by the entity; and
inferring, by the management controller and based on the information, that the intrusion event has occurred.

3. The method of claim 2, wherein the predetermined state is a booting state while the processor is attempting to boot the data processing system.

4. The method of claim 2, wherein the predetermined state is a managed operating state while an operating system is managing operation of the processor.

5. The method of claim 2, wherein inferring that the intrusion event has occurred comprises:
comparing at least a portion of the attempted access activity to intrusion detection criteria; and
in an instance of the comparing where the at least the portion of the attempted access activity meets the intrusion detection criteria:
inferring that the intrusion event has occurred.

6. The method of claim 1, wherein identifying the remediation action comprises:
searching, by the management controller, a repository of remediation actions using the intrusion event as a key to identify the remediation action.

7. The method of claim 1, wherein the remediation action is performed, cooperatively between the management controller and the storage device using the side band channel, regardless of an operating state of the hardware resources.

8. The method of claim 1, wherein managing operation of the storage device comprises:
providing, by the management controller via the side band channel, a command to a controller of the storage device to perform the remediation action.

9. The method of claim 1, wherein the remediation action comprises:
updating operation of the storage device so that a processor of the hardware resources is unable to interact with the storage device.

10. The method of claim 1, wherein the remediation action comprises:
deleting at least a portion of data stored on the storage device so that the at least a portion of data is unavailable to a processor of the hardware resources.

11. The method of claim 1, wherein the intrusion event comprises at least one event selected from a list of events consisting of:
a credential-based attack;
a chassis intrusion event;
a firmware tampering event; and
a boot deviation attempt event.

12. The method of claim 1, wherein the unauthorized access comprises physical and/or logical access to the hardware resources without permission.

13. The method of claim 1, wherein the management controller operates independently from and is distinct from the hardware resources.

14. The method of claim 1, wherein the management controller is on a separate power domain from the hardware resources so that the management controller is operable while the hardware resources are inoperable.

15. A non-transitory machine-readable medium having instructions stored therein, which when executed by a processor, cause the processor to perform operations for managing operation of a data processing system, the operations comprising:
identifying, by a management controller of the data processing system, an occurrence of an intrusion event related to an entity attempting to gain unauthorized access to hardware resources of the data processing system;
based on the identifying:
identifying, by the management controller, a remediation action with respect to a storage device of the hardware resources, the remediation action being:
based on the intrusion event, and
adapted to place the storage device in a protected state; and
managing, by the management controller via a side band channel, operation of the storage device using the remediation action to facilitate continued provisioning of computer-implemented services after the intrusion event is addressed through, at least in part, performance of the remediation action.

16. The non-transitory machine-readable medium of claim 15, wherein identifying the occurrence of the intrusion event comprises:
obtaining, by the management controller via a second side band channel, information from a processor while the processor is operating in a predetermined state, the information comprising attempted access activity by the entity; and
inferring, by the management controller and based on the information, that the intrusion event has occurred.

17. The non-transitory machine-readable medium of claim 15, wherein managing operation of the storage device comprises:
providing, by the management controller via the side band channel, a command to a controller of the storage device to perform the remediation action.

18. A system, comprising:
a processor; and
a memory coupled to the processor to store instructions, which when executed by the processor, cause the processor to perform operations for managing operation of a data processing system, the operations comprising:
identifying, by a management controller of the data processing system, an occurrence of an intrusion event related to an entity attempting to gain unauthorized access to hardware resources of the data processing system;
based on the identifying:
identifying, by the management controller, a remediation action with respect to a storage device of the hardware resources, the remediation action being:
based on the intrusion event, and
adapted to place the storage device in a protected state; and
managing, by the management controller via a side band channel, operation of the storage device using the remediation action to facilitate continued provisioning of computer-implemented services after the intrusion event is addressed through, at least in part, performance of the remediation action.

19. The system of claim 18, wherein identifying the occurrence of the intrusion event comprises:
obtaining, by the management controller via a second side band channel, information from a processor while the processor is operating in a predetermined state, the information comprising attempted access activity by the entity; and
inferring, by the management controller and based on the information, that the
intrusion event has occurred.

20. The system of claim 18, wherein managing operation of the storage device comprises:
providing, by the management controller via the side band channel, a command to a controller of the storage device to perform the remediation action.
